(19) United States
(12) Patent Application Publication
(10) Pub. No.: US 2011/0221961 A1
(43) Pub. Date: Sep. 15, 2011

(54) SYNCHRONIZATION DATA DETECTION APPARATUS, SYNCHRONIZATION DATA DETECTION METHOD, AND RECORDING MEDIUM

(75) Inventor: Kouichi KURIHARA, Saitama (JP)

(73) Assignee: KABUSHIKI KAISHA TOSHIBA, Tokyo (JP)

(21) Appl. No.: 13/044,421

(22) Filed: Mar. 9, 2011

(30) Foreign Application Priority Data
Mar. 9, 2010 (JP) 2010-052371

(51) Int. Cl. H04J 3/06; H04N 5/08

(52) U.S. Cl. 348/525; 370/503; 348/E05.017

(57) ABSTRACT

According to an embodiment, a synchronization byte detection portion includes: an 0x47 detector configured to sequentially read in TS data in predetermined units from a memory storing TS data including predetermined synchronization data, and detect a predetermined synchronization byte; a counter configured to count a number of times the predetermined synchronization byte is detected by the 0x47 detector; and a determination instruction portion configured such that, in a case where after detecting an initial predetermined synchronization byte, the 0x47 detector reads in TS data at predetermined intervals and the 0x47 detector does not detect the predetermined synchronization byte at the predetermined intervals a predetermined number of times in succession, the determination instruction portion causes the 0x47 detector to sequentially read in TS data from next TS data after the initial predetermined synchronization byte.

### CROSS-REFERENCE TO RELATED APPLICATION

This application is based upon and claims the benefit of priority from the Japanese Patent Application No. 2010-52371 filed on Mar. 9, 2010; the entire contents of which are incorporated herein by reference.

### FIELD

An embodiment described herein relates generally to a synchronization data detection apparatus, a synchronization data detection method, and a recording medium.

### BACKGROUND

Conventionally, contents data to be received by a digital broadcast receiver is divided into a plurality of packets and transmitted. For example, a transport stream (hereunder, may be referred to as “TS”) that complies with the MPEG 2 (Moving Picture Expert Group 2) standard is constituted by a plurality of packets that each have a length of 188 bytes. For every 188 bytes, a synchronization byte, more specifically, a bit string of “0x47”, is included in the header portion of each packet. A digital broadcast receiver is configured to be able to identify the respective packets by detecting the synchronization bytes, and perform decryption processing of the data.

For example, in the case of an MPEG2 TS, a “0x47” (hexadecimal) byte is defined as synchronization data. Accordingly, for example, as disclosed in Japanese Patent Application Laid-Open Publication No. 11-73737, the digital broadcast receiver is configured to perform decryption processing of TS data after it is confirmed that “0x47” data has appeared in received TS data at intervals of 188 bytes a predetermined number of times or more.

However, since it is determined whether or not “0x47” data has been detected a predetermined number of times at intervals of 188 bytes, if byte data of the same bit string as “0x47” that is defined as the synchronization byte in an MPEG2 TS happens to be included in the TS data, a case may occur in which it is erroneously determined that a synchronization byte has been detected.

According to the conventional method described above, byte data is read out in sequence from the start of the TS data and it is determined whether or not the byte data matches the bit string “0x47”. When a given byte is a bit string “0x47”, it is determined whether or not there is also a bit string of “0x47” at an address located 188 bytes ahead the location of the address of the aforementioned byte with the bit string “0x47”. More specifically, unless a “0x47” byte appears a predetermined number of times at intervals of 188 bytes, a synchronization byte detection circuit determines that there are no synchronization bytes in the TS data that is the object of the detection processing.

Therefore, if a given byte is erroneously determined to be a bit string of “0x47”, even if a true synchronization byte exists between that given byte and a byte that is 188 bytes ahead the given byte, the data of the true synchronization byte will be skipped, that is, ignored, and will not be used in determining the existence of synchronization bytes.

Thereafter, although the synchronization byte detection circuit starts detection of synchronization bytes again, the TS data that has been previously used for determining the existence of synchronization bytes is not an object of the detection processing. More specifically, even if there is a packet that includes a true synchronization byte in the TS data previously used for determining the existence of synchronization bytes, the packet is discarded.

Although the contents data described above is data that has been broadcast, even in the case of contents data recorded on a storage medium or data delivered via the Internet or the like, the synchronization byte detection circuit likewise may discard a packet even if the packet includes a true synchronization byte between bytes at intervals of 188 bytes that have been previously used to determine the existence of synchronization bytes.

As described above, conventionally, even if a packet includes a true synchronization byte in TS data that has been used in a determination for detecting synchronization bytes, the packet is not used in subsequent detection processing of synchronization bytes.

### BRIEF DESCRIPTION OF THE DRAWINGS

FIG. 1 is a configuration diagram that illustrates a configuration of a digital broadcast receiver according to an embodiment;

FIG. 2 is a view for describing processing when a synchronization byte detection portion 5 starts a synchronization byte detection operation according to the embodiment;

FIG. 3 is a view illustrating a memory map of a memory that stores TS data for synchronization byte detection in the synchronization byte detection portion 5 according to the embodiment;

FIG. 4 is a view for describing processing of the synchronization byte detection portion 5 when a true synchronization byte is no longer detected, according to the embodiment;

FIG. 5 is a block diagram illustrating the configuration of the synchronization byte detection portion 5 according to the embodiment;

FIG. 6 is a flowchart illustrating an example of a flow of synchronization byte detection processing according to the embodiment; and

FIG. 7 is a view illustrating a memory map of a memory 12 according to the embodiment.

### DETAILED DESCRIPTION

According to an embodiment, a synchronization data detection apparatus can be provided that includes: a detection portion configured to sequentially read in transport stream data including predetermined synchronization data from a memory, and detect the predetermined synchronization data; a counting portion configured to count a number of times the detection portion detects the predetermined synchronization data; and a control portion configured to cause the detection portion to read in the transport stream data at predetermined intervals after initial predetermined synchronization data is detected by the detection portion, and when the detection portion does not detect the predetermined synchronization data a predetermined number of times in succession at the predetermined intervals, to cause the detection portion to read in data from next data after the initial predetermined synchronization data of the transport stream data.

An embodiment is described hereunder with reference to the drawings.

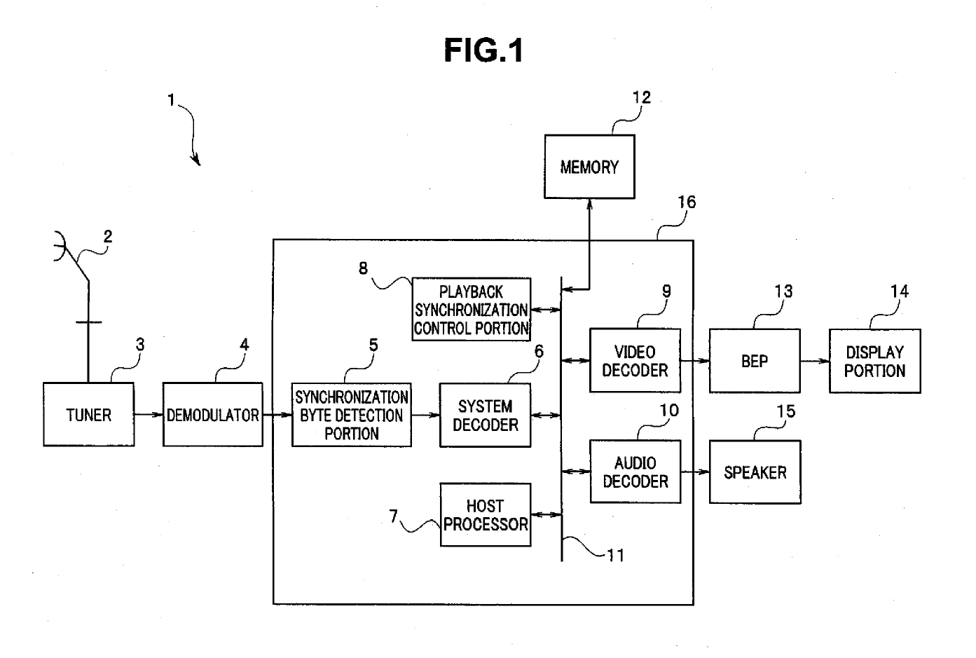

First, the configuration of a digital broadcast receiver according to the embodiment is described based on FIG. 1. FIG. 1 is a configuration diagram illustrating the configuration of a digital broadcast receiver according to the present embodiment.

A digital broadcast receiver 1 illustrated in FIG. 1 is a television receiver. The digital broadcast receiver 1 includes an antenna 2, a tuner 3, a demodulator 4, a synchronization byte detection portion 5, a system decoder 6, a host processor 7, a playback synchronization control portion 8, a video decoder 9, an audio decoder 10, a data bus 11, a memory 12, a back-end processor (hereunder, referred to as “BEP”) 13, a display portion 14, and a speaker 15.

A MPEG decoder 16 is constituted by the synchronization byte detection portion 5, the system decoder 6, the host processor 7, the video decoder 9, the audio decoder 10, and the data bus 11. Note that the synchronization byte detection portion 5 as a synchronization data detection apparatus need not be included in the MPEG decoder 16, but may be provided at an input stage to the MPEG decoder 16, instead.

As shown in FIG. 1, stream data of broadcast waves is input to the tuner 3 via the antenna 2. The tuner 3 converts the inputted radio frequency signals into baseband signals and outputs the baseband signals to the demodulator 4. The demodulator 4 subjects the inputted baseband signals to demodulation processing to reconstruct TS data, and outputs the TS data to the synchronization byte detection portion 5. The synchronization byte detection portion 5 identifies packets, and outputs the TS data to the system decoder 6. The demodulation processing carried out by the demodulator 4 includes, for example, at least one member of the group consisting of processing to convert an analog signal to a digital signal, multiplex demodulation when a received signal has been subjected to multiplex modulation, and other kinds of error correction processing and the like. Although only one tuner is shown in FIG. 1, the digital broadcast receiver 1 may include a plurality of tuners. When the digital broadcast receiver 1 includes a plurality of tuners, it is necessary to provide the same number of demodulators 4 and synchronization byte detection portions 5 as the number of tuners, and in such case it is possible to use a multi-demodulator. A single multi-demodulator can demodulate two or more baseband signals.

The system decoder 6 selects TS packets that satisfy a filter condition that is previously set from the host processor 7, for example, TS packets that have a set packet identifier (PID), extracts necessary data (information) from the packets, and outputs (or writes) the data to a buffer in the memory 12 that is previously set from the host processor 7 via the data bus 11. The buffer is set as a buffer region inside the memory 12 such as a DRAM. The data is sorted into video data and audio data by the system decoder 6.

The video data is output to a video STD buffer inside the memory 12. The audio data is output to an audio STD buffer inside the memory 12. The video data and audio data that have been sorted by the system decoder 6 are supplied to the video decoder 9 and the audio decoder 10, respectively, through the dedicated buffers provided in the memory 12.

The video decoder 9 decodes the video data supplied (or read) from the memory 12 in conformity with a vertical synchronizing signal (hereunder, referred to as “VSYNC”) supplied from the playback synchronization control portion 8, and outputs video information obtained as a result to the BEP 13. The BEP 13 subjects the video information to various kinds of image processing such as color correction, and displays the resulting video information on the display portion 14. The display portion 14 corresponds to, for example, any one of various display devices such as an LCD (Liquid Crystal Display), a PDP (Plasma Display Panel), and a CRT (Cathode Ray Tube).

The audio decoder 10 decodes the audio data supplied (or read) from the memory 12, and performs audio output of the audio information obtained as a result to the speaker 15.

The demodulated TS is input to the synchronization byte detection portion 5 as a synchronization data detection apparatus. The synchronization byte detection portion 5 detects synchronization bytes from the TS data, and supplies the detection result to the system decoder 6 together with the TS data. According to the present embodiment, a case is described in which the synchronization byte “0x47” of TS data according to MPEG 2 is taken as an example of synchronization data.

In this connection, the synchronization byte detection portion 5 may be provided inside the system decoder 6.

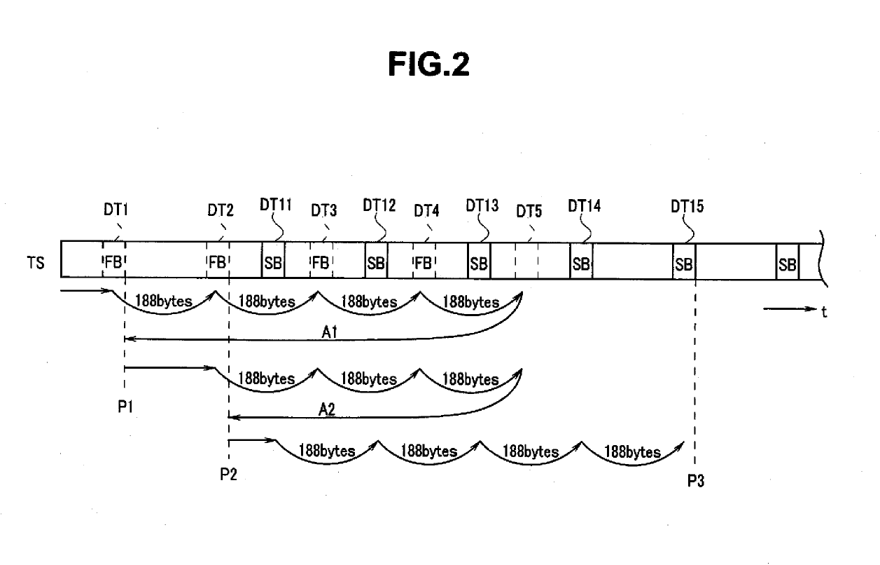

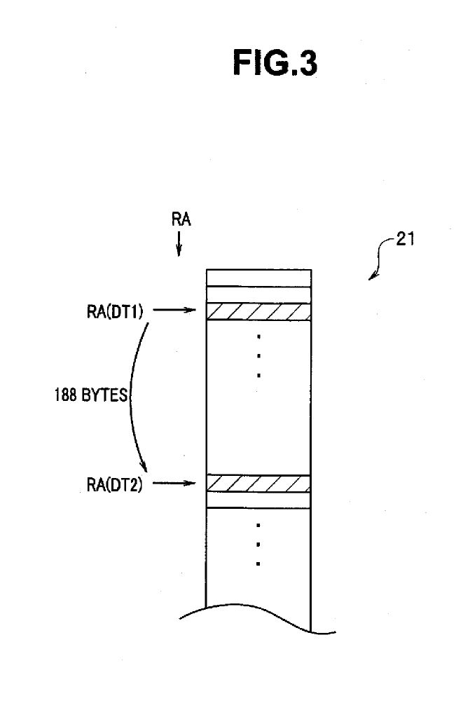

First, the flow of the overall detection operation of the synchronization byte detection portion 5 according to the present embodiment is described. FIG. 2 is a view for describing processing when the synchronization byte detection portion 5 starts a synchronization byte detection operation. Here, an example is described in which the synchronization byte detection portion 5 determines that synchronization bytes are true synchronization bytes when the detected synchronization bytes have been detected a predetermined number of times or more in succession. In this case, the predetermined number of times is five times or more. FIG. 3 is a view that illustrates a memory map of a memory in which TS data for synchronization byte detection is stored in the synchronization byte detection portion 5.

As shown in FIG. 2, TS data that includes a plurality of packets is read out in predetermined units, in this case byte units, in sequence from the start of the addresses of the memory that stores the TS data.

When it is detected that TS data is a predetermined synchronization byte, in this case “0x47” data, while sequentially reading out the TS data, it is determined whether or not there is “0x47” data at predetermined intervals thereafter, more specifically, at predetermined intervals of 188 bytes.

According to FIG. 2, a data DT1 is an initial “0x47” data, and thereafter it is determined whether or not a data DT2 that is 188 bytes after the data DT1 is “0x47” data. FIG. 3 shows that the data DT1 is stored at an address RA(DT1) on the memory map, as illustrated by the diagonal lines in the figure. The data DT2 at an address RA(DT2) that is 188 bytes after the data DT1 is read out and used to determine whether or not the data is “0x47”. The TS data between the address RA(DT1) and the address RA(DT2) is skipped without being read. The data at each address RA is data of a single byte.

According to FIG. 2, the data DT2 is also “0x47” data, and furthermore data DT3 that is 188 bytes after the data DT2, and data DT4 that is a further bytes after the data DT3 are “0x47” data.

However, according to FIG. 2, data DT5 that is a further 188 bytes after the data DT4 is not “0x47” data. Hence, since the synchronization byte detection portion 5 does not detect “0x47” data at predetermined intervals for five times or more in succession, it determines that the “0x47” data of the data DT1, DT2, DT3, and DT4 that have been detected up to this time are not synchronization bytes. Subsequently, the synchronization byte detection portion 5 executes detection processing again with respect to synchronization bytes in a similar manner from the next data after the data DT1 that is initially detected. As shown by an arrow A1 in FIG. 2, the synchronization byte detection portion 5 returns to a position P1 that is the next address after the address RD(DT1), and executes the synchronization byte detection processing again from the position P1.

According to the second synchronization byte detection processing, since the data DT2 is “0x47” data, thereafter the synchronization byte detection portion 5 determines whether the data DT3 that is 188 bytes after the data DT2 is “0x47” data. According to FIG. 2, the data DT4 that is 188 bytes after the data DT3 is also “0x47” data.

However, according to the second synchronization byte detection processing also, the next data DT5 that is a further 188 bytes after the data DT4 is not “0x47” data. Hence, since the synchronization byte detection portion 5 does not detect “0x47” data at predetermined intervals for five times or more in succession, it determines that the “0x47” data detected up to this time are not synchronization bytes. Therefore, the synchronization byte detection portion 5 again executes detection processing for synchronization bytes in a similar manner from the next data after the data DT2 that has been initially detected in the second synchronization byte detection processing. As shown by an arrow A2 in FIG. 2, the synchronization byte detection portion 5 returns to a position P2 that is the next address after the address RD(DT2), and executes the synchronization byte detection processing again from the position P2.

According to the third synchronization byte detection processing, since a data DT11 is “0x47” data, thereafter the synchronization byte detection portion 5 determines whether data DT12 that is 188 bytes after the data DT11 is “0x47” data. According to FIG. 2, the data DT12 is also “0x47” data.

Similarly thereafter, the synchronization byte detection portion 5 performs synchronization byte detection processing and detects that, in the example shown in FIG. 2, there is “0x47” data at intervals of 188 bytes for five times in succession. Hence, in the third synchronization byte detection processing, when the data detected the fifth time is “0x47” data, the synchronization byte detection portion 5 determines that synchronization bytes have been detected.

More specifically, in the first and second synchronization byte detection processing, the data DT1 at address RA(DT1), the data DT2 at address RA(DT2), the data DT3 at address RA(DT3), and the data DT4 at address RA(DT4) are not predetermined synchronization bytes included in each packet, and are different data thereto. These data are separate data FB whose value happens to be “0x47”.

However, in the third synchronization byte detection processing of the data, the data DT11 at address RA(DT11), the data DT12 at address RA(DT12), the data DT13 at address RA(DT13), the data DT14 at address RA(DT4), and the data DT15 at address RA(DT15) are true synchronization bytes SB.

As described above, according to the present embodiment, synchronization byte detection processing is performed in which TS data that is conventionally skipped is taken as an object of the synchronization byte detection processing, and thus synchronization byte detection can be performed in which packets are not omitted.

Further, even when successive synchronization bytes are no longer detected, detection of synchronization bytes is performed without omitting packets.

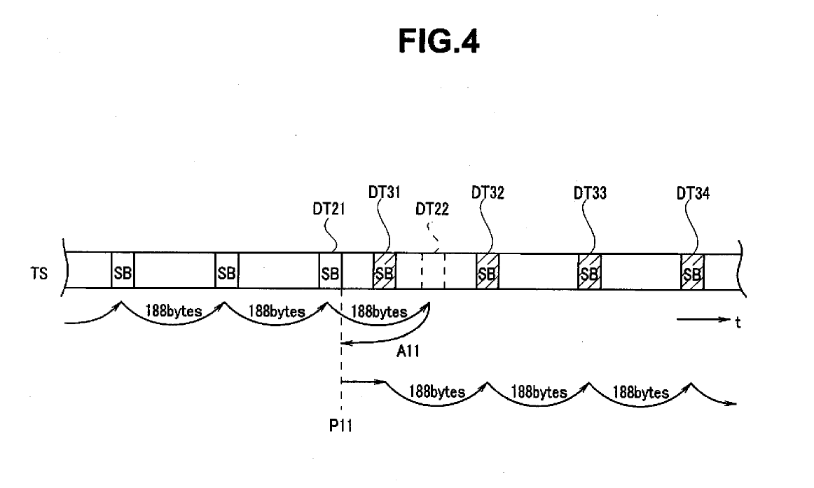

FIG. 4 is a view for describing processing of the synchronization byte detection portion 5 when true synchronization bytes are no longer detected.

FIG. 4 illustrates a case in which, after true synchronization bytes have been detected, read-out TS data is not “0x47” data when the synchronization byte detection portion 5 is determining whether or not TS data at regular intervals of 188 bytes is “0x47” data. According to FIG. 4, a case is illustrated in which although the data DT21 that was last read out is “0x47”, the next data DT22 that is 188 bytes after the data DT21 is not “0x47”.

In this case, the synchronization byte detection portion 5 executes detection processing for synchronization bytes from the next data after the data DT21 that was the last“0x47” data. As shown by an arrow A11 in FIG. 4, the synchronization byte detection portion 5 returns to a position P11 that is the next address after the address RD(DT21), and executes the above described synchronization byte detection processing from the position P11.

As a result, the synchronization byte detection portion 5 detects that the data at an address RA(DT31) is “0x47”, and thereafter, similarly to the example described in FIG. 2, the synchronization byte detection portion 5 determines whether or not there is “0x47” data at regular intervals of 188 bytes.

As described above, conventionally when true synchronization bytes are no longer detected after a true synchronization byte has been detected, detection of synchronization bytes is carried out using the TS data thereafter. However, according to the present embodiment described above, when true synchronization bytes are no longer detected after a true synchronization byte has been detected, synchronization byte detection processing is carried out from the next data after the last synchronization byte. Hence, as shown in FIG. 4, in a case in which there is data DT31 of a true synchronization byte shortly after the data DT21, the data DT31 is utilized in the synchronization byte detection processing without the packet that includes the true synchronization byte data DT31 being overlooked.

In this connection, in the example illustrated in FIG. 2, a configuration may also be adopted in which synchronization byte detection processing is performed such that, when an address that is the object of synchronization byte detection processing has returned to the position P1 or P2, as shown by the arrow A1 or A2, the data FB which has already been determined as not being synchronization byte data is removed from the target data.

Next, the configuration of the synchronization byte detection portion 5 is described.

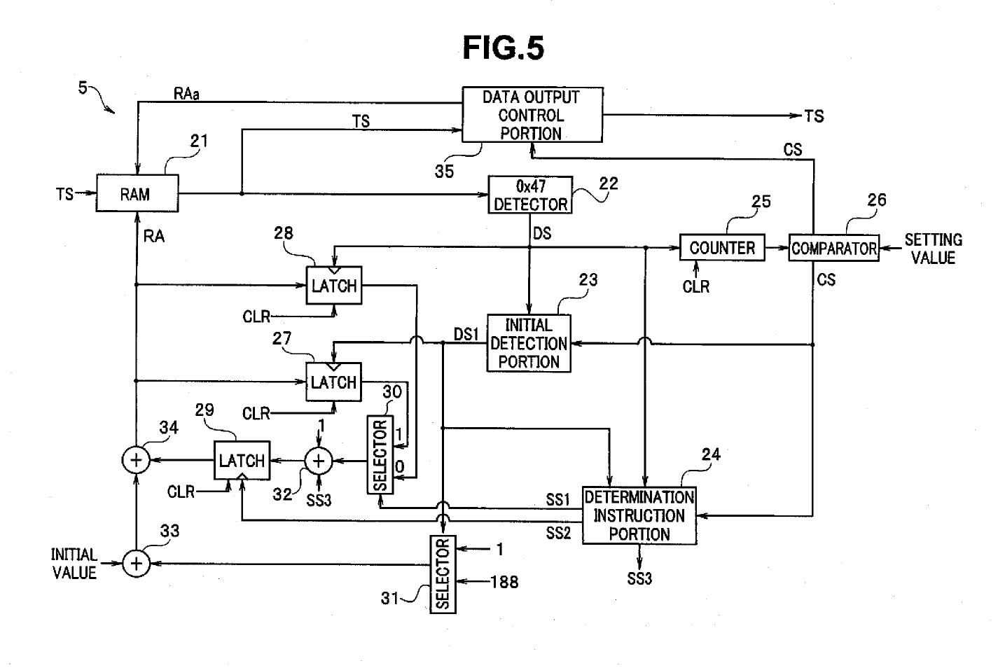

FIG. 5 is a block diagram that illustrates the configuration of the synchronization byte detection portion 5. The synchronization byte detection portion 5 is a circuit that includes a RAM 21, an 0x47 detector 22, an initial detection portion 23, a determination instruction portion 24, a counter 25, a comparator 26, latch circuits (hereunder, referred to simply as “latch”) 27, 28, and 29, selectors 30 and 31, adders 32, 33, and 34, and a data output control portion 35.

Restored TS data that has been subjected to demodulation processing is input to the RAM 21 from the demodulator 4.

The 0x47 detector 22 is a circuit that detects whether byte data read out from the RAM 21 is “0x47” data. When the 0x47 detector 22 detects that read-out byte data is “0x47” data, the 0x47 detector 22 outputs a detection signal DS with a value “1”. The 0x47 detector 22 constitutes a detection portion that sequentially reads in TS data in predetermined units from the RAM 21 that is a memory that stores TS data including predetermined synchronization data, and detects the predetermined synchronization data.

The initial detection portion 23 is a circuit that detects that “0x47” data has been initially detected after the start of detection of synchronization bytes. When a detection of “0x47” data is an initial detection, the initial detection portion 23 outputs an initial detection signal DS1.

The determination instruction portion 24 is a circuit that outputs instruction signals SS1 and SS2 in accordance with whether or not “0x47” data has been detected a predetermined number of times. The determination instruction portion 24 also outputs a control signal SS3 to the adder 32.

The instruction signal SS1 is “1” when a comparison result signal CS that is described later is “0” and the detection signal DS is not output. Further, the instruction signal SS1 is “0” when the comparison result signal CS is “1” and the detection signal DS is not output, i.e. when the detection signal DS is “0”. The determination instruction portion 24 outputs the instruction signal SS1 in this manner in accordance with the value of the comparison result signal CS and the detection signal DS.

The instruction signal SS2 is a latch timing signal for the latch 29.

The counter 25 is a counter that counts the number of times “0x47” data is detected. The counter 25 constitutes a number-of-detections counting portion that counts the number of times the 0x47 detector 22 detects predetermined synchronization data.

The comparator 26 is a comparison circuit for determining whether or not a count value CN of the counter 25 has exceeded a preset setting value CNS. When the count value CN exceeds the setting value CNS, the comparator 26 outputs the comparison result signal CS with a value “1”. In this case, the setting value CNS is “4”. Accordingly, the comparator 26 outputs the comparison result signal CS when the count value CN is 5 or more.

The latch 27 is a circuit that holds a read address in the RAM 21 of byte data when “0x47” data is initially detected, based on the initial detection signal DS1 from the initial detection portion 23. The latch 27 constitutes an address holding portion that holds an address in the RAM 21 of initially detected synchronization data.

The latch 28 is a circuit that holds a read address in the RAM 21 when “0x47” data is detected, based on the detection signal DS from the 0x47 detector 22. The latch 28 constitutes an address holding portion that holds an address in the RAM 21 of the latest synchronization data when the 0x47 detector 22 detects predetermined synchronization data.

The latch 29 is a circuit for holding an address RA and supplying the read address to the RAM 21 via the adder 34.

The selector 30 is a circuit that selects and outputs an address being held in either one of the latch 27 and the latch 28 based on the instruction signal SS1 from the determination instruction portion 24. When the instruction signal SS1 is “1” the selector 30 selects and outputs the value of the latch 27, and when the instruction signal SS1 is “0” the selector 30 selects and outputs the value of the latch 28.

The selector 31 is a circuit that selects and outputs either one of “1” and “188” based on the initial detection signal DS1 from the initial detection portion 23. The selector 31 is a selecting portion that selects either one of “1” and “188” as a value corresponding to a predetermined interval. The selector 31 constitutes a selecting portion that selects and outputs “1” until the initial detection portion 23 initially detects predetermined synchronization data, and selects and outputs a “value corresponding to a predetermined interval” after the initial detection portion 23 has initially detected the predetermined synchronization data.

The adder 32 is a circuit that adds “1” to an address outputted from the selector 30 and outputs the resulting value to the latch 29 in accordance with the control signal SS3.

The adder 33 is a circuit into which a predetermined initial value is input, and is also a circuit that holds data and adds “1” or “188” as the output of the selector 31 to the held data and outputs the resulting value.

The adder 34 is a circuit that adds the output of the latch 29 to the output of the adder 33 and outputs the result.

The data output control portion 35 is a circuit that, based on the comparison result signal CS of the comparator 26, outputs a read address RAa for data output to the RAM 21, acquires TS data from the RAM 21, and outputs the TS data. The outputted TS data is decoded at the system decoder 6.

Next, the operations of the synchronization byte detection portion 5 shown in FIG. 5 are described.

When reception of digital broadcasting begins, demodulated TS data is input to the synchronization byte detection portion 5 from the demodulator 4. Each of the latches 27, 28, and 29 and the counter 25 is initialized by input of an initialization signal CLR. As shown in FIG. 3, the TS data is stored in the RAM 21 in byte units in sequence from a predetermined address in the received order. According to FIG. 3, TS data is stored in byte units from the start of the RAM 21.

Since the TS data is sequentially stored in the RAM 21, when a predetermined amount of TS data is stored in the RAM 21, the adder 33 outputs an initial value, for example “0”. At the adder 34, a value obtained by adding “0” to the output “1” thereof is output to the RAM 21 as an address RA(1) as a read address.

At a predetermined timing, the address RA(1) is input to the RAM 21, and the RAM 21 outputs data of 1 byte that corresponds to the read address RA to the 0x47 detector 22.

As a result, TS data at the address RA(1) is read out, and the 0x47 detector 22 determines whether or not the inputted TS data is “0x47”. If the inputted TS data is not “0x47”, the 0x47 detector 22 does not output anything.

The above described operation is repeated until the 0x47 detector 22 detects “0x47” data. More specifically, the read address RA is incremented by “1” each time as the result of adding the output “1” from the selector 31 to data held in the latch 33, and supplying a value obtained by that addition to the RAM 21. The respective data at the addresses RA(2), RA(3) . . . is repeatedly read out from the RAM 21 until “0x47” data is read out.

When the inputted data is “0x47”, the 0x47 detector 22 outputs the detection signal DS with a value “1” to the initial detection portion 23, the counter 25, and the latch 28. Since the outputted detection signal DS is the first detection signal DS, the count value of the counter 25 changes to “1”. When the initial “0x47” is detected, thereafter processing starts that determines whether or not there is “0x47” data at regular intervals of 188 bytes.

The latch 28 holds the address RA at the time the RAM 21 outputs “0x47” data. According to the example shown in FIG. 2, the address RA(DT1) of the data DT1 is latched by the latch 28.

Since the 0x47 detector 22 outputs the detection signal DS when the data from the RAM 21 is “0x47”, the initial detection portion 23 determines whether the detection signal DS from the 0x47 detector 22 is the first signal since starting the synchronization byte detection. When the detection signal DS from the 0x47 detector 22 is the first detection signal DS, the initial detection portion 23 outputs the initial detection signal DS1 to the determination instruction portion 24, the latch 27 and the selector 31.

Based on input of the initial detection signal DS1, the latch 27 holds address data for the “0x47” data that the RAM 21 has initially output. More specifically, when the first detection signal DS is output, the initial detection signal DS1 is supplied to the latch 27, and the latch 27 latches the address at the time when the initial “0x47” data is detected. According to the example shown in FIG. 2, the address RA(DT1) of the data DT1 is latched by the latch 27.

Based on input of the comparison result signal CS, the detection signal DS, and the initial detection signal DS1, the determination instruction portion 24 outputs the instruction signal SS1 as a selection signal to the selector 30 and outputs the instruction signal SS2 as a hold signal to the latch 29. At this time, the instruction signal SS1 is “0”, and the instruction signal SS2 as a hold signal is “1”. Further, at this time, based on the control signal SS3, the adder 32 outputs the output of the latch 28 to the latch 29 without adding “1” thereto. Based on the instruction signal SS2 from the determination instruction portion 24, the latch 29 holds and outputs the output of the latch 28.

The selector 31 selects and outputs “188” based on the initial detection signal DS1 from the initial detection portion 23.

As a result, the adder 34 adds the “188” from the selector 31 to the output of the latch 29, and outputs the value obtained by that addition to the RAM 21 as the read address RA. In the example illustrated in FIG. 2, the address RA(DT2) is supplied to the RAM 21.

Next, upon detecting “0x47” data, the 0x47 detector 22 outputs the detection signal DS, and the detection signal DS is outputted to the initial detection portion 23, the counter 25, and the latch 28.

Since the detection signal DS is not the first detection signal, the initial detection portion 23 does not output the initial detection signal DS1.

Because the detection signal DS is the second detection signal DS, the count value of the counter 25 changes to “2”.

The latch 28 holds the address RA at the time when the RAM 21 outputted the “0x47” data. According to the example shown in FIG. 2, the address RA(DT2) of the data DT2 is latched by the latch 28.

According to the example shown in FIG. 2, a similar operation as that described above is carried out with respect to data from the data DT2 to the data DT4. More specifically, based on input of the comparison result signal CS and the detection signal DS, the determination instruction portion 24 outputs the instruction signal SS1 as a selection signal to the selector 30, and outputs the instruction signal SS2 as a hold signal to the latch 29. The selector 30 selects the output of the latch 28, and outputs the selected output to the latch 29. The latch 29 outputs the data that is being held to the adder 34. The adder 34 adds the output “188” of the selector 31 to the output of the latch 29, and outputs a value obtained by that addition to the RAM 21 as the read address RA. In the example shown in FIG. 2, the addresses RA(DT3), RA(DT4), and RA(DT5) are supplied in sequence to the RAM 21.

However, in the example shown in FIG. 2, the data DT5 is not “0x47” data. Since the data DT5 is not “0x47” data, the 0x47 detector 22 outputs the detection signal DS with a value “0”. Since the detection signal DS is “0” and the comparison result signal CS is “0”, the determination instruction portion 24 outputs the instruction signal SS1 with a value “1” to the selector 30.

Upon input of the instruction signal SS1 with the value “1”, the selector 30 selects the output of the latch 27 (that is, the first address RA(DT1) at which “0x47” is detected), and outputs the selected output to the adder 32. Based on the control signal SS3, the adder 32 adds “1” to the output from the selector 30, and outputs the resulting value to the latch 29. Based on the instruction signal SS2, the latch 29 latches and outputs the output of the adder 32.

In this case, the adder 34 adds the initial value “0” to the output of the latch 29, and supplies a value obtained by that addition to the RAM 21 as a read address. In the example shown in FIG. 2, as shown by the arrow A1, the next address after the initial data DT1 is supplied to the RAM 21. Further, the count value of the counter 25 is cleared.

As described above, the determination instruction portion 24 constitutes a control portion that, after the 0x47 detector 22 has detected the initial predetermined synchronization data, causes the 0x47 detector 22 to read in TS data at predetermined intervals, and when the 0x47 detector 22 does not detect the predetermined synchronization data a predetermined number of times in succession at the predetermined intervals, causes the 0x47 detector 22 to read in TS data from the next data after the initial predetermined synchronization data. The control portion is constituted by the circuit illustrated in FIG. 5, excluding the RAM 21, the data output control portion 35, the 0x47 detector 22, and the comparator 26.

The operations thereafter are the same as the above described operations with respect to the data DT1 to DT4. Subsequently, when “0x47” data is detected, second processing is started that determines whether or not “0x47” data exists at intervals of 188 bytes.

According to the example shown in FIG. 2, in this second processing also, since the data DT5 is not “0x47” data, the determination instruction portion 24 supplies the instruction signal SS1 with a value “1” to the selector 30. Further, in the example illustrated in FIG. 2, as shown by the arrow A2, the next address after the initial data DT2 is supplied to the RAM 21. Further, the count value of the counter 25 is cleared. In this case, the count value of the counter 25 is cleared after it has reached “3”.

The operations thereafter are the same as the above described operations with respect to the data DT1 to DT4. Subsequently, when “0x47” data is detected, third processing is started that determines whether or not “0x47” data exists at intervals of 188 bytes. As shown in FIG. 2, the operations with respect to the data from the data DT11 to DT15 are the same as for the data from the data DT1 to DT4 described above. However, because the data DT15 is “0x47” data, the count value of the counter 25 becomes “5”, and the comparison result signal CS at the comparator 26 becomes “1”.

The data output control portion 35 can receive the comparison result signal CS with the value “1”, output a read address RAa to the RAM 21, and acquire TS data from the RAM 21.

The data output control portion 35, for example, at a timing at which the comparison result signal CS with the value “1” is received, generates and outputs a read address RAa so as to read out TS data starting from the “0x47” data that is five “0x47” data items before the data DT15, from the TS data that has been read out. The data output control portion 35 reads out TS data consecutively from the read address RAa, and outputs the TS data to the system decoder 6.

In this connection, the synchronization byte detection portion 5 continues its operations even after the comparator 26 has output the comparison result signal CS with the value “1”. The synchronization byte detection portion 5 determines whether or not “0x47” data appears at intervals of 188 bytes.

Further, after the comparator 26 has output the comparison result signal CS with the value “1”, if data at intervals of 188 bytes is no longer “0x47” data, the 0x47 detector 22 does not output the detection signal DS with the value “1”. When a detection signal DS with a value “0” is input, since the comparison result signal CS is “1”, the determination instruction portion 24 outputs the instruction signal SS1 with a value “0” to the selector 30.

Upon receiving the instruction signal SS1 with the value “0”, the selector 30 selects the output of the latch 28, and outputs the output of the latch 28 to the adder 32. According to the example shown in FIG. 4, the last address RA(DT21) at which “0x47” has been detected is selected. The adder 32 adds “1” to the output received from the selector 30, and outputs the resulting value to the latch 29. In response to the instruction signal SS2, the latch 29 latches and outputs the output from the adder 32. According to the example shown in FIG. 4, as illustrated by an arrow A11, the next address after the data DT21 that is the last “0x47” data of the relevant TS data is supplied to the RAM 21.

As described above, the determination instruction portion 24 constitutes a control portion that, when the predetermined synchronization data is not detected at a predetermined interval after the predetermined synchronization data has been detected a predetermined number of times, instructs the synchronization data detection portion to sequentially read in transport stream data from the position of the next transport stream data after the predetermined synchronization data that was last detected, and detect the existence or non-existence of the predetermined synchronization data.

Further, the counter 25 and the latches 27 and 28 are cleared. Although the operations thereafter are the same as the above described operations, since detection of “0x47” data is carried out from the next address after the address at which “0x47” data was last detected, as shown in FIG. 4, in a case in which there is data SB of a true synchronization byte shortly after the address at which “0x47” data was last detected, the data of the true synchronization byte is not overlooked.

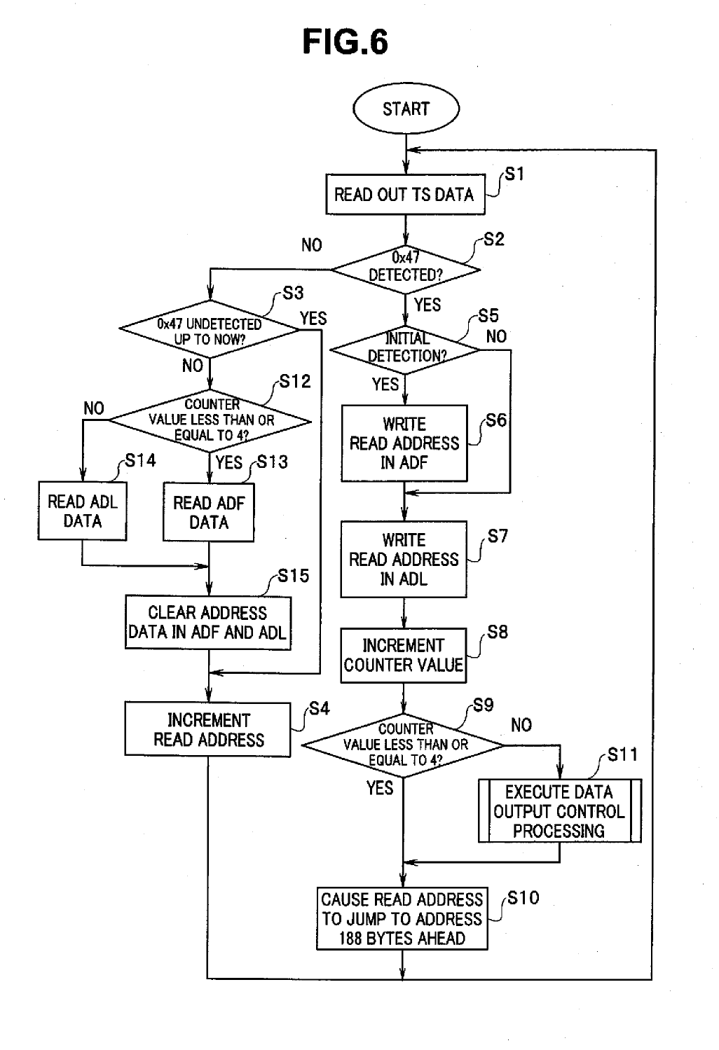

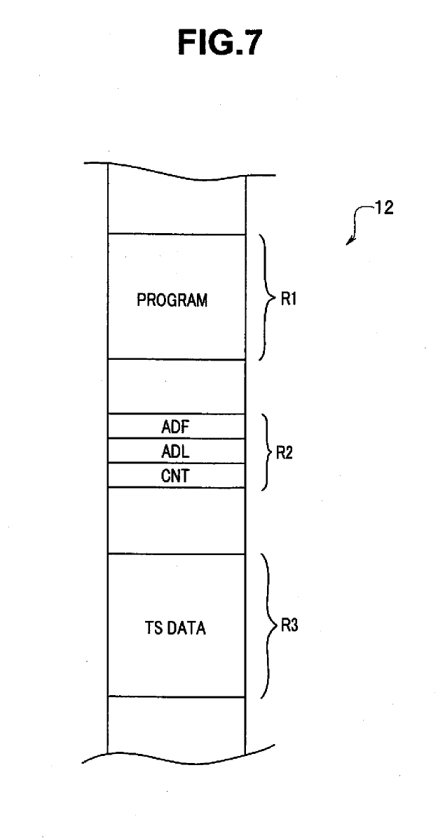

Note that the synchronization byte detection portion 5 can be implemented with a software program (hereunder, referred to as “program”). When implementing the synchronization byte detection portion 5 with a program, the synchronization byte detection portion 5 is constituted by the host processor 7 and the memory 12. FIG. 6 is a flowchart that illustrates an example of the flow of synchronization byte detection processing. FIG. 7 is a view that illustrates a memory map of the memory 12. The program illustrated in FIG. 6 is stored in a ROM or the like inside the host processor, and is expanded in a predetermined storage region R1 of the memory 12, such as a DRAM, and executed.

When TS data is output from the demodulator 4, the host processor 7 temporarily stores the TS data in sequence in a predetermined storage region R3 of the memory 12.

When a predetermined amount or more of the TS data is stored, the processing shown in FIG. 6 is executed. The host processor (hereunder, referred to simply as “CPU”) 7 reads out TS data in byte units from the start of the storage region R3 (step (hereunder, abbreviated to “S”) 1). Next, the CPU 7 determines whether or not the TS data that is read out is “0x47” data (S2). S2 constitutes a synchronization data detection portion configured to sequentially read out TS data in predetermined units from a memory storing TS data including a plurality of packets, and detect the existence or non-existence of predetermined synchronization data.

If the TS data that is read out is not “0x47” data (“No” in S2), the CPU 7 determines whether “0x47” has not been detected up to that time (S3). If “0x47” has not been detected (“Yes” in S3), the CPU 7 increments the read address RA (S4), and the processing returns to S1.

In contrast, if the TS data that is read out is “0x47” data (“Yes” in S2), the CPU 7 determines whether or not this is the first detection of “0x47” data (S5). S5 constitutes an initial detection portion that detects whether the predetermined synchronization data is detected for the first time.

When this is the first detection of the “0x47” data (“Yes” in S5), the CPU 7 writes the address of the detected “0x47” data, that is, the read address RA, in a storage region ADF of a predetermined first address in the memory 12 (S6). The storage region ADF constitutes an address holding portion that holds an address in the memory of the initially detected synchronization data. Further, the CPU 7 writes the read address RA into a storage region ADL of a predetermined second address in the memory 12 (S7).

As illustrated in FIG. 7, the storage regions ADF and ADL in which the read address is written and a storage region CNT in which a counter value that is described later is written are previously secured in a storage region R2 in the memory 12.

Further, when detection of “0x47” data is not the first detection (“No” in S5), the CPU 7 writes the address of the detected “0x47” data, that is, the read address RA, in the storage region ADL of a predetermined second address in the memory 12 (S7). The storage region ADL constitutes an address holding portion that holds the address in the memory of the most recent synchronization data when the predetermined synchronization data has been detected.

The CPU 7 increments the counter value (S8). Since the counter value has been initially cleared, the counter value of the storage region CNT becomes “1” at the time of the first detection. S8 constitutes a number-of-detections counting portion that, when the predetermined synchronization data is successively detected at predetermined intervals, counts the number of detections of the predetermined synchronization data from the time when the predetermined synchronization data is first detected.

The CPU 7 determines whether or not the counter value of the storage region CNT is 4 or less (S9). If the counter value is 4 or less (“No” in S9), the CPU 7 causes the read address RA to jump to an address that is “188” bytes forward thereof (S10). More specifically, in S10, the read address RA changes to an address that is 188 bytes ahead of the current read address, and the processing returns to S1.

When the counter value is 5 or more (“Yes” in S9), the CPU 7 reads out TS data and causes the system decoder 6 to execute data output control processing (S11). The processing then moves to S10.

If the TS data that is read out is not “0x47” data (“No” in S2) and “0x47” has been detected before that time (“No” in S3), the CPU 7 determines whether or not the counter value is 4 or less (S12).

When the counter value is less than or equal to 4 that is a predetermined number of times (“Yes” in S12), the CPU 7 reads the address of the storage region ADF (that is, the address at which “0x47” data was first read out) (S13).

Further, when the counter value is greater than or equal to 5 that is a predetermined number of times (“No” in S12), the CPU 7 reads the address of the storage region ADL (that is, the address at which “0x47” data was last read out) (S14).

Next, the CPU 7 clears the data of the storage regions ADF and ADL (S15), and increments the data that is read in S13 or S14 (S4). The processing then returns to S1.

S3, S12, S13, and S4 constitute a determination instruction portion that determines whether or not predetermined synchronization data has been detected a predetermined number of times, and when the predetermined synchronization data is not detected a predetermined number of times, instructs the synchronization data detection portion to sequentially read out transport stream data from position of the next transport stream data after the predetermined synchronization data that has been initially detected, and detect the existence or non-existence of the predetermined synchronization data.

S3, S12, S14, and S4 constitute a determination instruction portion that, when predetermined synchronization data is not detected at a predetermined interval after the predetermined synchronization data has been detected a predetermined number of times, instructs the synchronization data detection portion to sequentially read out transport stream data from the position of the next transport stream data after the predetermined synchronization data that has been last detected, and detect the existence or non-existence of the predetermined synchronization data.

As described above, the processing of the synchronization byte detection portion 5 may be implemented by a program, and the same advantages can be obtained as when implementing the processing of the synchronization byte detection portion 5 with the above described hardware.

Note that although an example is described above in which the program is executed by the host processor 7, the processing may be executed by another processor.

According to the present embodiment as described above, it is possible to realize a synchronization data detection apparatus that can detect the existence or non-existence of synchronization data without omitting packets, as well as a method thereof and a program for that purpose.

Although an example of a television receiver is described above, the synchronization data detection apparatus of the above described present embodiment can also be applied to a HDD recorder and a PC and the like that process a transport stream including a plurality of packets.

In particular, a TS of image data when supplying contents data via a network is not connected consecutively in an orderly manner in packet units. If packets are omitted when performing playback or the like of this kind of data, a problem such as a delay in the start of decryption processing will arise because data necessary for playback is lacking.

More specifically, although there are few packet omissions if the contents have been created by connecting divided data in 188 byte units of TS data packets as in the case of motion picture contents, in a case where contents are to be provided using a network, for example, the Internet, there are many instances in which the contents are not edited and created in TS data packet units. In such cases also, the synchronization data detection apparatus of the above described present embodiment is effective.

The above described synchronization data detection apparatus can also be formed, for example, as a single semiconductor chip, or can be formed as a circuit of one portion of a semiconductor chip of a decoder such as an MPEG decoder.

The whole or a part of the program code of the program that executes the operations described above is a computer program product recorded or stored in a storage medium, such as a portable medium like a flexible disk or a CD-ROM, or a hard disk drive. A computer reads the program to execute all or a part of the operations. Alternatively, the whole or a part of the program code of the program can be distributed or provided through a communication network. A user can easily implement the synchronization data detection apparatus according to the present embodiment by downloading the program through the communication network and installing the program in a computer, or installing the program in a computer from a recording medium.

While a certain embodiment has been described, this embodiment has been presented by way of example only, and are not intended to limit the scope of the inventions. Indeed, the novel devices and methods described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A synchronization data detection apparatus, comprising:
a detection module configured to sequentially read transport stream data comprising synchronization data followed by packet body data, and to detect the synchronization data;
a counter configured to count a number of times the detection module detects the synchronization data; and
a controller configured to cause the detection module to read the transport stream data at intervals after synchronization data is first detected by the detection module, and, when the detection module fails to detect the synchronization data after the previously detecting synchronization data for a first number of times, to cause the detection module to read the packet body data associated with the previously detected synchronization data of the transport stream data.

2. The synchronization data detection apparatus of claim 1, wherein:
the controller further comprises a first address holder configured to hold an address in a memory of the previously detected synchronization data; and
the controller causes the detection module to read data from data of a next address after the previously detected synchronization data based on an address in the first address holder when the detection module fails to detect the synchronization data after the previously detecting synchronization data for the first number of times.

3. The synchronization data detection apparatus of claim 2, further comprising:
a first selector configured to select either one of “1” and a value corresponding to the interval;
wherein:
the first selector is configured to select and output “1” until the synchronization data is first detected, and to select and output a value corresponding to the interval after the synchronization data is first detected;
the transport stream data is sequentially read in first units from the memory while incrementing a read address of the memory by the “1” using an output of the “1” of the first selector until the synchronization data is first detected; and
the transport stream data is sequentially read in the first units from the memory while incrementing a read address of the memory by the value corresponding to the interval using an output of the value corresponding to the interval of the first selector after the synchronization data is first detected.

4. The synchronization data detection apparatus of claim 1, comprising:
a comparator configured to compare a count value of the counter and the first number of times previously set, and to output a comparison result signal that indicates that the count value has reached the first number of times;
wherein the controller is configured to determine whether the synchronization data has been detected the first number of times based on the comparison result signal.

5. The synchronization data detection apparatus of claim 1, wherein:
the controller causes the detection module to read data from the packet body data immediately after the last synchronization data that the detection module detected when the synchronization data is undetected for a first number of times after the synchronization data is previously detected.

6. The synchronization data detection apparatus of claim 5, further comprising:
a second address holder configured to hold an address in the memory of latest synchronization data when the synchronization data detection module detects the synchronization data;
wherein the controller is configured to instruct the synchronization data detection module to read data sequentially from next transport stream data after the last detected synchronization data, and to detect the synchronization data when the synchronization data is undetected at the interval after the synchronization data is detected the first number of times, based on an address in the second address holder.

7. The synchronization data detection apparatus of claim 2, wherein:
the controller causes the detection module to read in data from the packet body data immediately after synchronization data that the detection module last detected of the transport stream data when the synchronization data is undetected after previously detecting the synchronization data for the first number of times.

8. The synchronization data detection apparatus of claim 7, further comprising:
a second address holder configured to hold an address in the memory of latest synchronization data when the synchronization data detection module has detected the synchronization data;
wherein the controller is configured to instruct the synchronization data detection module to read in data sequentially from next transport stream data after the last detected synchronization data, and to detect the synchronization data when the synchronization data is undetected for the interval, after the synchronization data has been continuously detected for the first number of times, based on an address held in the second address holder.

9. The synchronization data detection apparatus of claim 8, further comprising:
a second selector configured to select one of the first address holder and the second address holder; and
an adder;
wherein the transport stream data is read sequentially in the first units from the memory while incrementing by “1” an address of the memory that is selected by the second selector.

10. The synchronization data detection apparatus of claim 1, wherein the transport stream data is MPEG2 transport stream data, and the synchronization data is synchronization byte data of respective packets of the MPEG2 transport stream data.

11. A television receiver comprising a synchronization data detection apparatus, the synchronization data detection apparatus, comprising:
a detection module configured to sequentially read transport stream data comprising synchronization data configured to be used for synchronizing data, and to detect the synchronization data;
a counter configured to count a number of times the detection module detects the synchronization data; and
a controller configured to cause the detection module to read the transport stream data at intervals after synchronization data is first detected by the detection module, and to cause the detection module to read data from the packet body data associated with the previously detected synchronization data of the transport stream data when the detection module fails to detect the synchronization data after previously detecting synchronization data for the first number of times.

12. A synchronization data detection method, comprising:
sequentially reading transport stream data comprising synchronization data from a memory that stores the transport stream data, and detecting the synchronization data;
counting a number of times the synchronization data is detected; and
reading in the transport stream data at intervals after synchronization data is first detected, and reading data from the packet body data associated with the previously detected synchronization data of the transport stream data if the synchronization data is undetected after previously detecting the synchronization data was for a first number of times.

13. The synchronization data detection method of claim 12, further comprising:
reading data from data of a next address after the previously detected synchronization data, based on an address in the memory of the previously detected synchronization data when the synchronization data is undetected after previously detecting the synchronization data for the first number of times.

14. The synchronization data detection method of claim 13, further comprising:
selecting and outputting “1” until the previously detected synchronization data is detected, and selecting and outputting a value corresponding to the interval after the synchronization data is first detected;
sequentially reading out the transport stream data in first units from the memory while incrementing a read address of the memory by the “1” using the “1” that is output until the synchronization data is first detected; and
sequentially reading out the transport stream data in first units from the memory while incrementing a read address of the memory by the value corresponding to the interval using the value corresponding to the interval, after the synchronization data is first detected.

15. The synchronization data detection method of claim 12, further comprising:
comparing a count value of the number of detections and the first number of times that is previously set, and outputting a comparison result signal that indicates that the count value has reached the first number of times; and
determining whether the synchronization data has been detected the first number of times based on the comparison result signal.

16. The synchronization data detection method of claim 12, further comprising:
reading out data from the packet body data immediately after last detected synchronization data when the synchronization data is undetected after previously detecting the synchronization data for the first number of times.

17. The synchronization data detection method of claim 16, further comprising:
reading data in sequence from next transport stream data after the last detected synchronization data, and detecting the synchronization data, when the synchronization data is undetected at the intervals after the synchronization data has been detected the first number of times, based on an address of latest synchronization data in the memory saved in a second address holder when the synchronization data is detected.

18. The synchronization data detection method of claim 13, further comprising:
reading out data from the packet body data associated with previously detected synchronization data when the synchronization data is undetected after previously detecting the synchronization data for the first number of times.

19. The synchronization data detection method of claim 18, further comprising:
reading out in sequence from next transport stream data after the previously detected synchronization data, and
detecting the synchronization data when the synchronization data is undetected after previously detecting the synchronization data for the first number of times, based on an address of latest synchronization data in the memory saved in a second address holder when the synchronization data has been previously detected.

20. A non-transitory computer readable medium configured to store a program comprising instructions for:
reading in sequentially transport stream data comprising synchronization data and packet body data, and detecting the synchronization data;
counting a number of times the synchronization data is detected; and
reading the transport stream data after synchronization data is first detected, and reading data from the packet body data associated with the previously detected synchronization data of the transport stream data if the synchronization data is undetected after previously detecting the synchronization data for a first number of times.
